(19) United States
(12) Patent Application Publication
(10) Pub. No.: US 2006/0060040 A1
(43) Pub. Date: Mar. 23, 2006

(54) Arm mounted safety cutting tool

(76) Inventor: Brian D Wichner, Otter Rock, OR (US)

Correspondence Address: Brian D Wichner, P O Box 24, Otter Rock, OR, 97007, US

(21) Appl. No.: 10/529,034

(22) PCT Filed: Sep. 22, 2003
(86) PCT No.: PCT/US03/29728

§ 371 Date: Mar. 23, 2005

Related U.S. Application Data
(60) Provisional application No. 60/412,695, filed on Sep. 23, 2002.

(51) Int. Cl. B26B 29/00; B26B 3/00

(52) U.S. Cl. 83/13; 30/294; 30/314

(57) ABSTRACT

An arm-mounted cutting tool for hands-free, rapidly cutting line, string, or slender rope. The cutting tool employs a sliding guide worn on, and fitted snugly and firmly to, the user's forearm. The sliding guide is used to guide line, string, or slender rope into a sharp blade member that is interiorly located in a blade support opening so that no human body extremities, such as a finger, can reach the blade and be accidentally cut. The blade member according to one preferred embodiment consists of two opposing linear cutting edges which intersect at a mutually produced apex. The two opposing cutting edges of this so-called “V”-shape blade, and the sharp apex they produce together, make a very effective blade for cutting line, string, or slender rope in a single pass.

### PRIORITY DOCUMENTS CLAIMED

U.S. Provisional Application 60/412,695

### TECHNICAL FIELD

This invention relates to an arm-mounted cutting tool, and a procedure, for cutting line, string, or slender rope quickly, as required during an emergency.

### BACKGROUND OF THE INVENTION

1. Field of the Invention

The present invention relates to a cutting tool with a safety feature. In particular, this invention is a line-cutting tool worn on the user's forearm which can be used during an emergency such as when a line has the immediate potential to cause bodily harm by being, or becoming, under tension. Such emergencies occur in activities such as commercial fishing, paragliding, SCUBA diving, and in the relatively new kite-related sports such as kite surfing, kite skiing, and kite buggying. The present invention can cut line very quickly and efficiently in a single pass of the blade member across the line. The invention is safe to carry and use because the blade member is interiorly located in a blade support which is shaped to prevent parts of the human body, such as a finger, from contacting the blade member, while allowing slender line easy access. This blade concealment idea is also utilized generally in letter openers which allow sheet-like material contact with the blade member, but not fingers.

2. Background Art

In recent years new designs and materials of kites and related equipment have helped make feasible new power-kiting sports, such as kite boarding, kite skiing, and kite buggying. These sports, rapidly growing in popularity worldwide, involve the use of a large, very powerful kite to generate pulling forces great enough to propel the kite sailor against sliding friction and other forms of resistance. Working with these large forces makes it highly desirable for the kite sailor to have the means to very quickly de-power, or release, the kite for the sake of sailor safety. For example, the powerful kites used in kite surfing can easily propel the kite surfer accidentally, with virtually no warning, to more than 5 meters in the air in the order of one second. It is imperative that any method used to de-power the kite work very quickly and efficiently. In addition, prevailing wind conditions, such as wind speed, direction, and gustiness, change quickly and unexpectedly. The pulling force generated by the kite is proportional to the wind speed, so gusty conditions are extremely dangerous. A kite can easily pull its user into rocks, trees, or buildings. The kite sailor needs to always have the ability to quickly de-power his/her kite.

There are available a number of known systems for de-powering and releasing kites. The simplest way of releasing a kite is to simply let go of the control bar, or handle(s). This may not be possible for either of two reasons. First, the kite lines may be accidentally wrapped around unintended objects, preventing the simple release of the kite and its concomitant power. Second, many kite sailors employ shackles and other semi-permanent connections, such as harness hooks, which do not allow quick disengagement while the line is under relatively high tension. FIG. 1 demonstrates a common situation in kite boarding, showing the use of a popular kite control bar 30, some details of which can be found in the disclosure of U.S. Pat. No. 6,273,369 B1, used in conjunction with a harness hook 31 to connect the kite sailor with the kite (not shown). The harness hook is retained to the sailor's body via a body harness 32. The kite sailor can pull the kite bar, against the force of the kite, towards his/her harness hook so that the harness loop 33, which is a part of the control bar, can be hooked onto the harness hook. The kite sailor optionally does this to free his/her arms from the constant burden of holding the fill force of the pulling kite. The harness loop will stay engaged to the harness hook as long as there is at least a small tension on the kite lines 34S and 34P. The kite sailor can disengage the harness loop from the harness hook by pulling the control bar towards the harness hook so that the sailor's arms effectively bypass the line of tension that was originally through the harness loop from the control bar to the sailor's body. When this occurs the harness loop simply falls out of the harness loop by gravity. If the harness loop is engaged with the harness hook and the kite sailor wishes to release the kite during an accident or emergency this would be very difficult to impossible while the kite is pulling with a very large force, because the kite sailor's arms would need to overcome and exceed the tension with which the kite is pulling. The present invention allows the kite sailor to cut either of the kite lines 34 (or both) so that the kite will instantly spill air and cease to pull.

Presently available control bars employing quick release systems work well in most cases, when no events occur out of the ordinary during the course of the kite sailing. Unfortunately circumstances which occur that can place the kite sailor or other persons nearby in danger are not uncommon. Other quick release systems, like those employing snap shackles (see U.S. Pat. No. 5,195,223, Quick Release Apparatus, issued to T. Tylaska), are unreliable and inefficient. For example, snap shackles may not operate if any sand or foreign matter is present in the mechanism. Also the action required by the kite sailor to release the kite via the snap shackle requires some amount of physical precision and time; these elements are not usually available in a life-threatening emergency posed by power-kites. In any case, there are situations that can occur, involving some sort of entanglement of the kite lines, which would prevent any type of quick release system from operating to release the kite. A situation has occurred quite a few times, sometimes causing death of one of the kite sailors involved: A first kite sailor may lose control of their kite, and may even lose the kite from themselves. Their kite may subsequently fly into a second kite sailor or their kite lines, resulting in a very dangerous entanglement. This is particularly a dangerous situation because both kites, although most likely flying chaotically and uncontrollably, together generate a very large amount of force—double the force with which the entangled kite sailor can cope or control. Recently a professional kite boarder was dragged to her death under these circumstances. This type of incidence will occur more frequently as the popularity of power-kite sports continues to increase.

Some precautious kite sailors carry a knife which can be used to cut kite lines during emergencies. Carrying a knife can, in itself, be dangerous because of the possibility that the cutting edge could become exposed, for example if the knife fell out of its carrying sheath unintentionally. In addition, grabbing at a knife may not be a fast enough action during an emergency. Quick and easy access to a conventional-type knife could be made possible, but at the expense of having this knife more easily released during undesired times, at which time it could become a severe danger to the holder or persons nearby.

In addition, the use of a knife in an emergency may be more of a hazard than a help: If a person were to use a conventional knife as a safety cutting tool, assuming for the moment that the person could even get to this tool quickly enough, then the open exposed blade could create its own hazards during a particularly chaotic situation, such as when the person is being dragged awkwardly and violently by the line or lines that they wish to cut.

The present invention allows the kite sailor to take an ultimate step to release the kite-generated power from the sailor, namely by cutting the line or lines with a cutter that will not itself present a hazard to the kite sailor. In addition, the present invention can be safely carried in a position where it can be quickly and instinctively utilized in an emergency. Furthermore, both hands of the kite sailor are free from holding the present invention even during its use. A kite sailor's hands being free and unconstrained are a requirement for operating a power kite

The present invention, a cutting tool in constant deployment and readiness while worn on the forearm of the user, allows both of the user's hands to be unconstrained, even during cutting action. The cutting tool's blade member is interiorly located in a blade support in order to provide protection against injury of the user. The cutting tool includes an arm shield that facilitates highly effective guidance of the line into the blade member. The cutting tool utilizes a blade member which is able to cut line in a single pass.

Danish Patent No. 16013 shows a hand-supported cord cutter including a hand-harness that supports a cutting edge. Although the “U”-shaped blade support offers some protection from user injury, this invention is not suitable for use with any activities that require both of the user's hands and wrists to be free and unconstrained, as for power-kite sports. In addition, the Danish Patent lacks what the present invention provides; an arm shield which efficiently guides the line into the blade member. Also, U.S. Pat. Nos. 1,201,840, and 1,574,392 show corn-husking devices worn over the hand and wrist. These inventions also constrain the user's hands and wrists, and though the husking hooks are not sharp they are not provided with any protection from injury to a user. U.S. Pat. No. 737,539, and British Patent No. 139,951 both show wrist-mounted blades. In both patents the blades are exposed, offering no protection from injury. In addition, both patents have the blade operable perpendicularly to the arm direction, precluding the option of providing an effective arm shield. U.S. Pat. No. 640,817 also has no protection from blade injury, no arm shield, and is designed to fit on, and unfortunately constrain, the user's hand. A number of patents teach the art of wearing a cutting tool as a ring on a user's finger, for example, U.S. Pat. Nos. 745,994 and 1,143,857. Cutting tools worn on the finger cannot provide the same effect as the arm shield of the present invention for providing efficient guidance of the line into the blade member. Also the cutting ability of a finger-based cutting tool is highly dependent on the orientation of the corresponding hand. This fact introduces many degrees of freedom to the problem of intercepting a line in space. In other words, it is very difficult to aim for the line to cut it. Also, the required forces involved in cutting line are not easily afforded from a finger as compared to an arm. A further problem with a finger mounted cutter is that the cutter is precariously close to the kite lines held by the kite sailor's hands, presenting a likelihood of inadvertent kite line cutting. In contrast, an arm mounted cutter, as in the present invention, has the cutter on the opposite side of the hands from the kite lines.

### BRIEF SUMMARY OF THE INVENTION

In this description of the present invention the single term “line” includes the range from thread, string, and chord, up to slender rope. Kite line for power kites fits within this range. In this context “line” is the line to be cut utilizing the cutting tool. “Cutting line” is a term that refers to the action of severing said line.

Briefly stated, the invention in a preferred form is an arm-mounted safety cutting tool, herein called cutting tool, to be employed when traction kites are used, including kites used to power kite surfers, kite skiers, and kite buggyers, which utilize lines which have an immediate potential to cause bodily harm by being, or becoming, under tension. The cutting tool has an efficient cutting edge designed to cut line in a single pass. This sharp cutting edge is partially concealed by a blade support with dimensions and shape that do not allow sharp cutting edge contact with objects significantly larger than the type of slender line typically used in controlling power kites. This is an important safety feature of the present invention. For example, the kite sailor's fingers could not be cut by the blade under any circumstances. Furthermore, a sliding guide worn on the user's forearm is smoothly attached to the blade support allowing the line to be cut to have extremely easy access to the cutting edge. Thus the present invention can be used quickly and instinctively, as will be explained later in the ensuing description.

The cutting tool can be very easily and conveniently carried by the user without hindering the use of his or her hands.

### BRIEF DESCRIPTION OF THE SEVERAL VIEWS OF THE DRAWINGS

FIG. 1 is a perspective view demonstrating a common method of semi-permanently connecting the kite sailor to the kite.

FIG. 2 is a side-elevational view of the cutting tool.

FIG. 3 is a perspective view of the cutting tool attached to a forearm, as in a preferred embodiment.

FIG. 4 is a diagrammatical figure demonstrating how the cutting tool of FIG. 3 cuts line.

FIG. 5 is a diagrammatical figure demonstrating how the cutting tool of FIG. 3 is safe by not allowing fingers to be cut.

FIG. 6 is a sectional view of a portion of the cutting tool taken along the line 6-6 of FIG. 2.

FIG. 7 is a sectional view of a portion of the cutting tool taken along the line 7-7 of FIG. 2.

FIG. 8A is a sectional view of a portion of the cutting tool taken along the line 8-8 of FIG. 2 including a section of the tensioned line to be cut.

FIG. 8B is sectional view of a portion of the cutting tool taken along the line 8-8 of FIG. 2 including a section of a non-tensioned line to be cut, and a hand which is used in the method to cut such a line.

FIG. 9 is a perspective view from below of the cutting tool split along the center plane of symmetry. FIG. 9a is without a blade member and FIG. 9b is with a blade member.

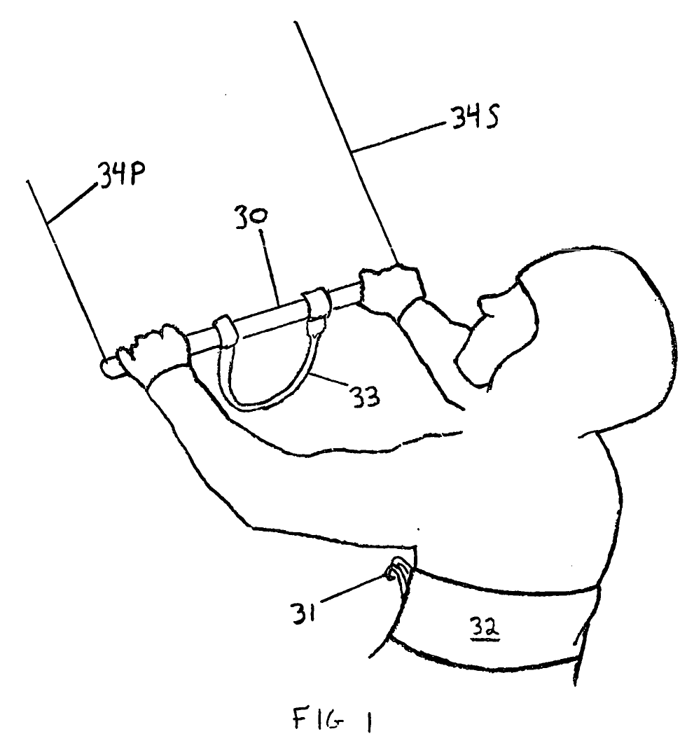

### DETAILED DESCRIPTION OF THE INVENTION

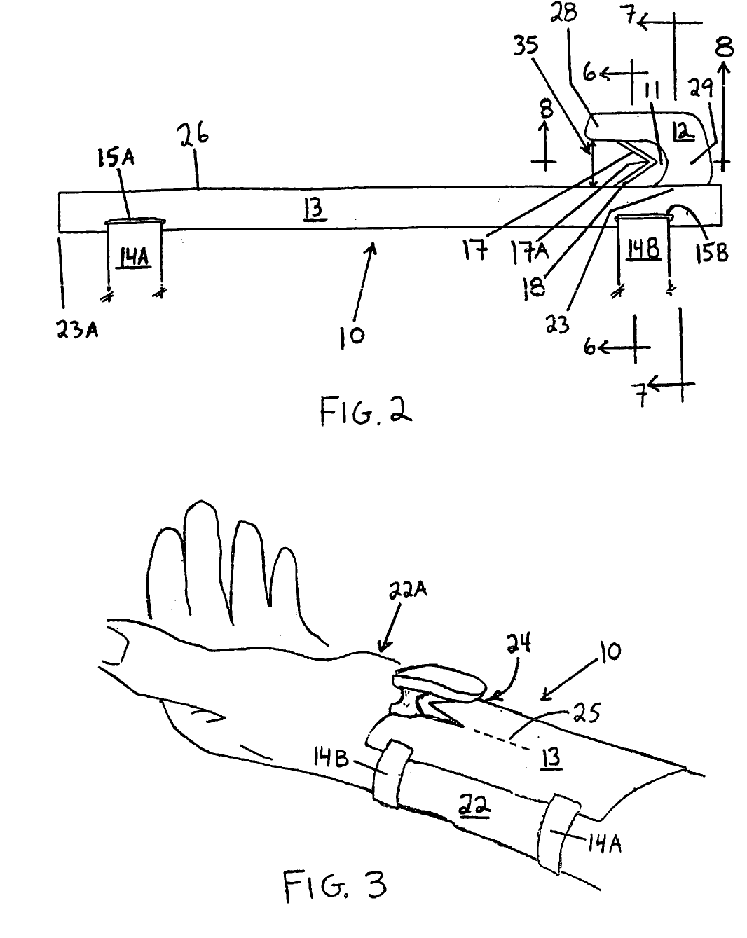

With reference to the drawings wherein like numerals represent like parts throughout the figures, the invention described herein, a rapid response safety cutting tool, or cutting tool, is generally designated by the numeral 10. Cutting tool 10 comprises a blade member 11, a blade support 12, a sliding guide 13, and arm straps 14A and 14B, depicted in FIG. 2. The sliding guide allows line with smaller diameter than the entrance height to slide freely on its surface, guiding the line into a blade support opening 24, until the line impinges on the blade member, at which point the line is cut in a single pass if the line is pulled against the blade member with a large enough force. In the particular embodiments shown in the drawings and herein described, the cutting tool is designed with somewhat arbitrary dimensions depicted in the figures, and to be worn by a kite sailor on the underside of the sailor's forearm. However, it should be understood that the principles of the present invention are equally applicable to virtually any form of cutting tool that has the advantages set forth herein, and useful to people other than a kite sailor. Therefore, it is not intended to limit the principles of the present invention to the specific embodiments shown and such principles should be broadly construed.

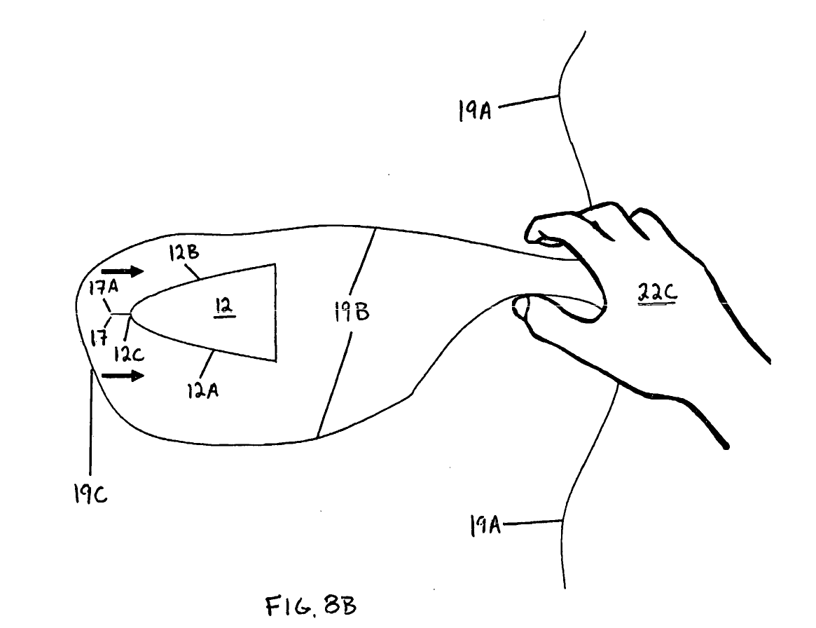

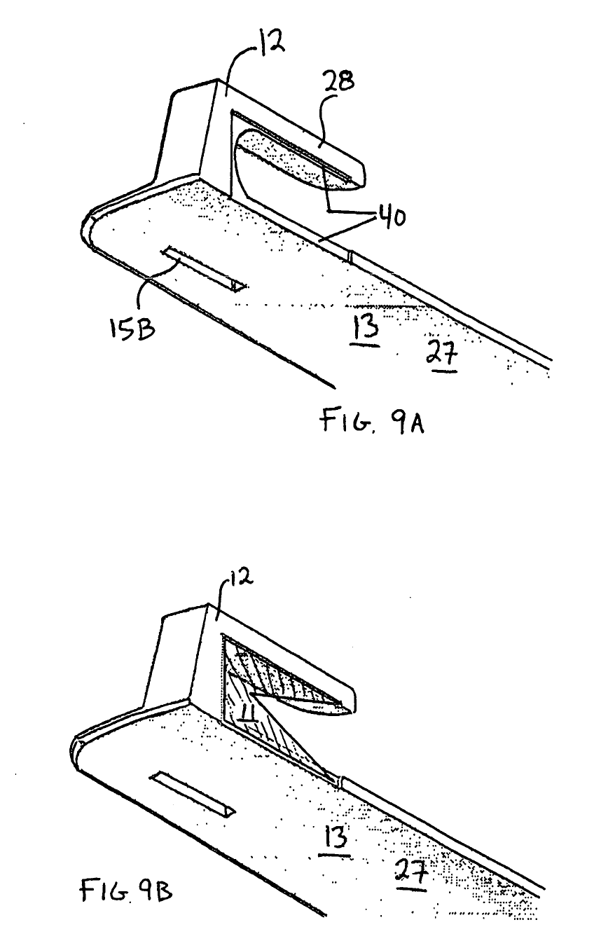

The cutting tool is to be designed to fit and operate on the forearm (not shown in FIG. 2) of the user. The cutting tool can be placed on the underside or upper side of the forearm depending on the user's preference. Thus the sliding guide, which in this preferred embodiment is a thin plastic shell, is generally contoured to be tightly and comfortably placed on the user's forearm, held securely by the arm straps. The sliding guide is concavely cylindrical, or near-cylindrical, towards the bottom 27, against the forearm with its long axis of symmetry 25 closely parallel to the forearm. The sliding guide length is defined as the distance from the sharp cutting edge apex to the sliding guide's rear end 23A. The sides of the sliding guide extend down the sides of the forearm the amount of which is not critical to the basic ideas of this invention, and a preferred embodiment can be easily determined without undue experimentation. In the preferred embodiment herein illustrated the sliding guide sides extend slightly down the sides of the forearm. In order to allow line to slide smoothly and uninhibitedly on the top 26 of the sliding guide in the direction of the sliding guide's long axis of symmetry the sliding guide's upper surface is largely inflexible and slidably smooth. In a preferred embodiment, the means for attaching the sliding guide to the user's forearm includes having two pairs of armstrap slots 15A and 15B on the sliding guide, each pair located near the opposite ends of the sliding guide. These armstrap slots are located close to the edge of the sliding guide, away from the part of the upper surface of the sliding guide that will most likely come in contact with the sliding line. These armstrap slots are used to connect hook and loop type armstraps 14A and 14B (partially illustrated in FIG. 2) to the cutting tool. The sliding guide is attached securely to the blade support 12 at the end of the sliding guide which is closest to the user's wrist, hereby named the front end 23. It is important that the contact line between the blade support and sliding guide at the upper surface of the sliding guide be smooth so it will not cause any hindrance to the free-sliding action of the line which is to be cut. The blade support 12 has three roles: One role is to securely hold the blade member 11; another role is to, in conjunction with the sliding guide, guide line into the sharp cutting edge of the blade member. This is accomplished by the blade support having a generally hook-shaped profile, or sideways L-shape atop the sliding guide. Finally, the other role is to partially conceal the blade member in order to prevent extremities of the human body coming into contact with the blade member. The outward-extending tongue 28 section of the blade support has a dual role of partially concealing the blade member, and supporting the top portion of said blade member. The blade support must be designed so that it will not interfere with any cutting action, so it is shaped in such a way as to allow line to pull against the blade member with minimal interference: Line is most effectively cut if the line is allowed to bend around the blade member at a sharp angle. The contoured shape of the vertical section 29 of the blade support allows the line to make a sharp angle around the blade member. This feature becomes less important as the line to be cut becomes more tensioned in a direction perpendicular to the plane of the blade member. However, a preferred embodiment of this invention is the feature that allows line to be cut by the user grabbing onto a section of the slack line and pulling the thus-formed loop apex against the blade member (Further explained and illustrated in FIG. 8B below). It is in this case that a concave contour of the vertical sides of the blade support becomes important. The blade member is located interiorly within the blade support in such a way as to dimensionally prevent any body extremities of the user to be able to come into contact with the sharp cutting edge 17. This access-limiting means is accomplished by appropriately designing the shape and dimensions of the blade support with respect to the position of the blade member, as explained in the following text and figures. The material of the sliding guide and blade support can be a moldable or machinable strong plastic, metal, or similar rigid material. The sliding guide and blade support can be an integral unit, i.e. a single part. Another embodiment is to have a separate blade support part that is attached, via screws or adhesive, to the sliding guide.

The blade member in the presently described preferred embodiment consists of two opposing linear cutting edges which intersect at a mutually produced apex 17A with an angle to be determined by simple trial and experiment for the most efficient cutting of the specific line for which the particular design is intended. The sharp cutting edge of the blade member can also be described as a “V”-shape, as in U.S. Pat. Nos. 1,338,248, 745,994, and British Patent No. 168,788, for example. There are possible embellishments to the blade member design of this preferred embodiment, for example, involving cutting-edge serrations. Also the blade member may actually be assembled from two separate opposing blades which may be easier than the manufacture of a blade member made of a single piece. Other sharp cutting edge blades shapes, such as “U”-shape, or linear, may be employed in embodiments of the cutting tool. Options for various blade shapes include serrated or smooth edges. Those familiar with the art of blade design can easily determine functional blade members for various embodiments of the cutting tool. In any case the blade member should be made from a material which does not easily rust or lose its sharpness even if used in sea (salt) water, for example stainless steel. In addition a petroleum-based gel, wax, or other similar material could be used to coat the blade member further protecting it from rusting. The coating material would be weak enough to easily yield to the line that is to be cut, not interfering with the cutting ability of the blade member.

There must be a smooth transition from blade support surface to the lower cutting edge 18 at the point where the lower cutting edge is embedded in the blade support. The reason is so the line to be cut can slide freely from the sliding guide surface onto the lower cutting edge until it is stopped and cut at the sharp cutting edge apex.

In the preferred embodiment shown in FIG. 3 the cutting tool 10 is positioned on the user's forearm 22 so that it does not impede any wrist or arm movement. For this reason the cutting tool is strapped down in a position along the length of the forearm that is clear of both the wrist 22A and the elbow (not shown). The sliding guide 13 can be shorter or longer in the dimension parallel to the forearm than what is shown in the figures. The sliding guide must not be so long that it interferes with any wrist and/or elbow movement, and it may not be so short that it becomes ineffective for intercepting and collecting a section of line into the blade support opening 24.

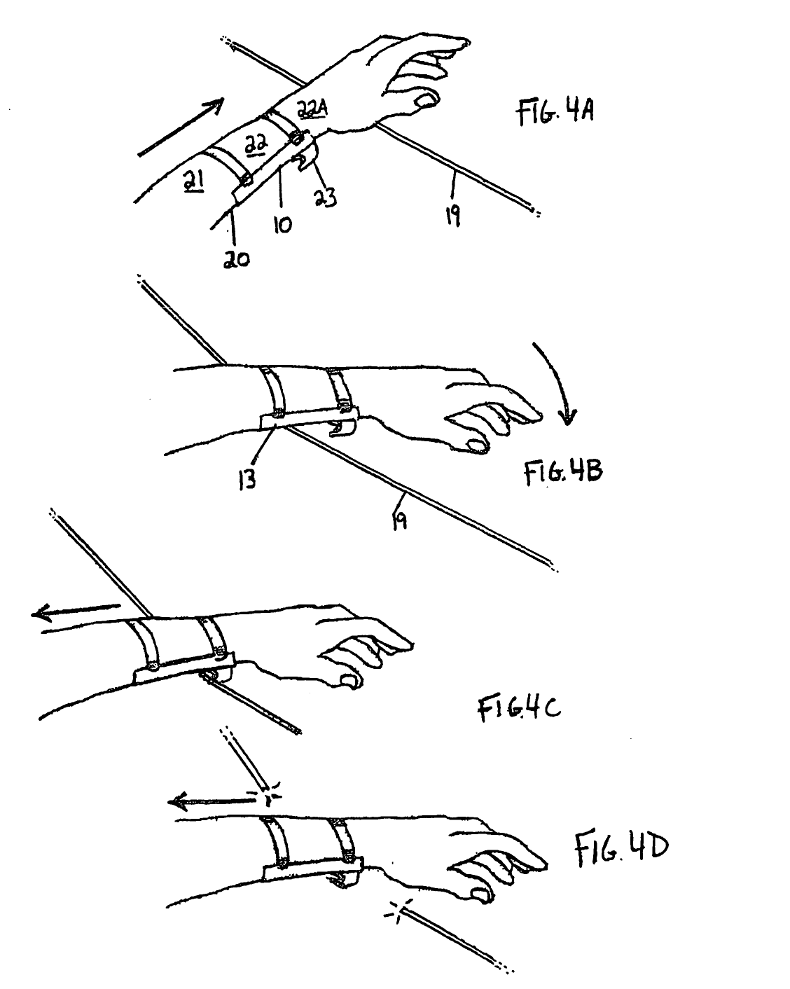

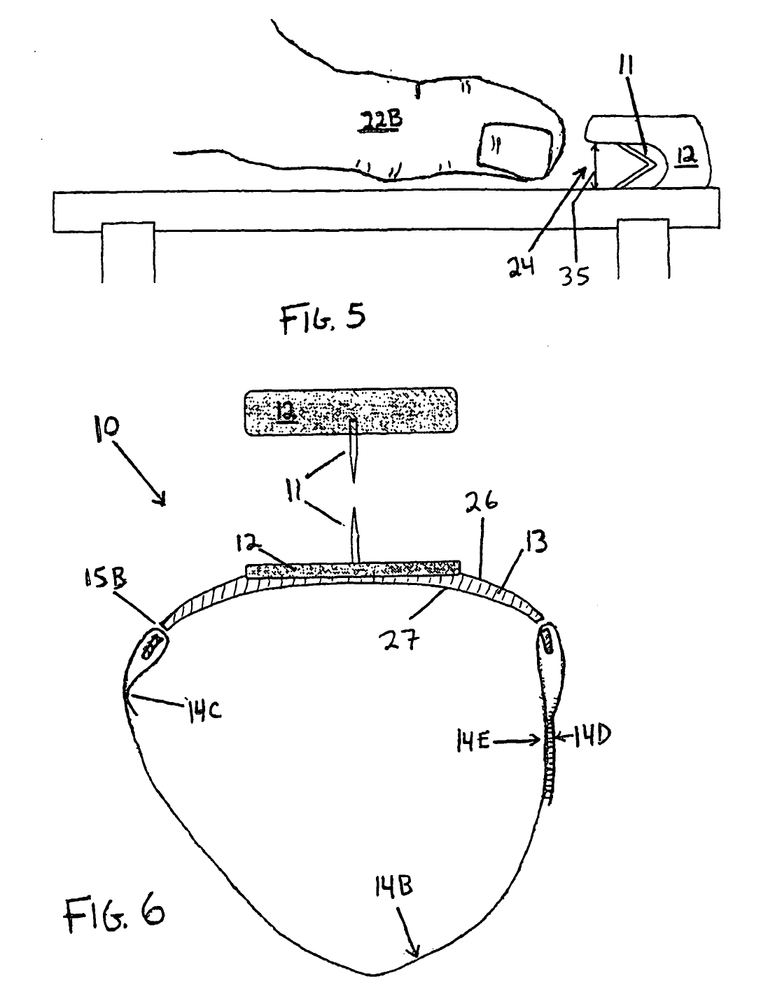

FIGS. 4A, 4B, 4C and 4D show a sequence of steps depicting the user using the cutting tool 10 to cut a taught line 19 in a single pass of the blade member across the line. Bold arrows depict the general motion of the arm. The present description of operation is for when the cutting tool is attached on the underside 20 (but the upper side 21 could be used as well) of the forearm 22, with the cutting tool attached so that the front end 23 is closest to the user's wrist 22A. Other attachment configurations are possible, for example the front end attached towards the user's elbow (not shown), but the attachment configuration presently described is most likely to be the most ergonomically effective. FIG. 4A, the first step, depicts the user thrusting his/her forearm forward over the line 19 so that the long axis of the sliding guide 13 is over, and approximately perpendicular to, the line. The user will attempt to bring the sliding guide's surface against the line by pivoting his/her forearm downward as in FIG. 4B, the second step. When this is accomplished the user will then engage the blade member by pulling his/her forearm towards himself/herself, as depicted in FIG. 4C, the third step, causing the line to slide into the blade member 11 via the sliding guide. At this point the line will be cut, as in FIG. 4D.

FIG. 5 demonstrates how the access-limiting means is adapted to provide protection to the user, illustrating a user's finger 22B trying to make contact with the blade member 11. The finger cannot be accidentally cut because it is too large to fit into the blade support opening 24 of the blade support 12. Only a relatively slender line can fit into the opening. The dimensions of the opening 24 can be easily designed so that even the smallest digit of a young child could not reach the cutting edge. To do this would sacrifice some of the ability of the cutting tool to cut line of comparable thickness, approximately 1 cm (0.39 in) diameter, to that of a child's smallest finger. However line much thicker than about 0.75 cm (0.30 in) is not often used in kite-related activities.

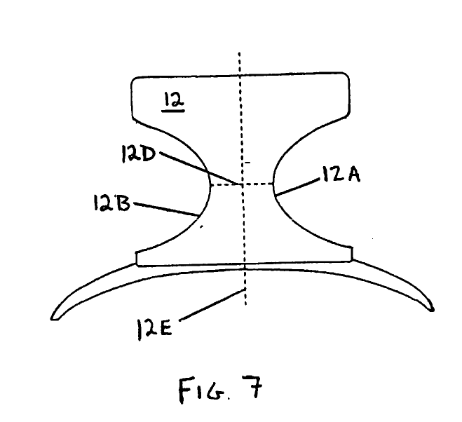

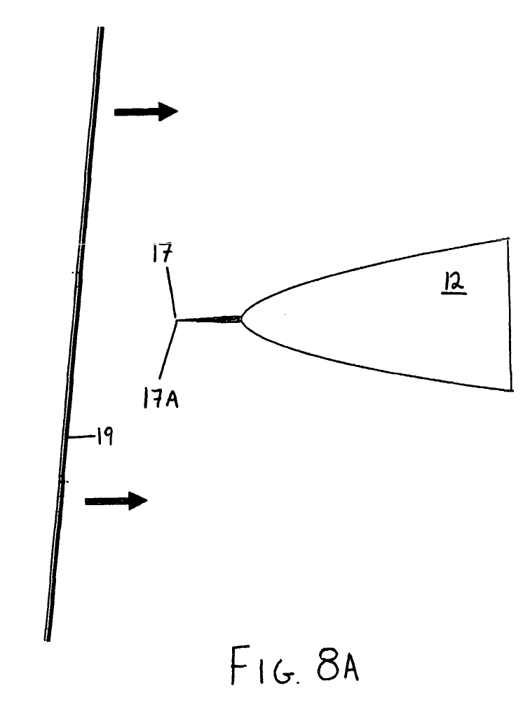

FIG. 6 shows a sectional view of the cutting tool 10 taken along the line 6-6 of FIG. 2 to help illustrate means for attaching sliding guide to the user's forearm. This view illustrates a simple preferred embodiment of a means for attaching the sliding guide, and thus the cutting tool, securely to the forearm (not shown) by using hook and loop straps (only the section of one of two is shown in FIG. 6). This embodiment and others are common and familiar to anyone associated with the art. The hook and loop front arm strap 14B has a stitched loop 14C on one end that is permanently attached through one of two front slots 15B. The other end of the front arm strap is guided through the other front slot, doubled back, as shown in FIG. 6, and pulled tightly downward and locked into position so a hook section of hook and loop strap 14D is engaged to a loop section of hook and loop strap 14E. FIG. 6 merely shows a general shape of the blade support 12 of one preferred embodiment. FIG. 6 also shows the sliding guide 13 and its general curved shape that conforms to the shape of a forearm. The distance the sliding guide should extend down either side of the forearm can be determined easily without undue experimentation so that the cutting tool will fit securely to the forearm and be comfortable to the user. The important aspects of the design of the blade support 12 can be seen in FIG. 7 which is a sectional view of a portion of the cutting tool taken along the line 7-7 of FIG. 2. Horizontal line 12D is introduced here to facilitate the description of the blade support shape and is defined to be connecting the apex of one lateral interior surface 12A to the apex of the other lateral interior surface 12B. Vertical line 12E is similarly introduced and is defined to be at the center of symmetry of the blade support and perpendicular to line 12D. The sharp cutting edge apex 17A (not shown in FIG. 7) and the intersection of lines 12D and 12E are two points that define a line that is perpendicular to the plane of the section of FIG. 7.

FIG. 7 in conjunction with the descriptions for FIGS. 8A and 8B illustrates the important aspects of the design of the blade support. FIGS. 8A and 8B include a sectional view of the blade support 12 taken along the line 8-8 of FIG. 2. FIGS. 8A and 8B help illustrate the contour of the blade support in a plane that includes the sharp cutting edge apex 17A, and depicts some differences between the actions of cutting taught line 19 and cutting untaught line 19A, respectively. The interior surface of the blade support is the surface area that is interiorly located within the blade support opening, and includes two lateral interior surfaces 12A and 12B. As can be seen in FIG. 8B the blade support's two lateral interior surfaces 12A and 12B mutually form an apex 12C which is in the same sectional plane 8-8 as the sharp cutting edge apex 17A. The shortest distance between the sharp cutting edge 17 and lateral interior surfaces 12A and 12B occurs in sectional plane 8-8 between the points at 17A and 12C. Also, the curves defined by the intersection of sectional plane 8-8 with the two lateral interior surfaces describe the closest distance between the two lateral interior surfaces, and this is the part of the blade support outlined in FIG. 8A and FIG. 8B. In FIG. 8A the taught line 19 is sliding towards the right, indicated by bold arrows, on the sliding guide 13 (not shown), entering the blade support opening 24 (not shown), after which it will impinge on the sharp cutting edge 17. The tensile nature of the taught line will allow it to be easily cut by the sharp cutting edge. Compare with FIG. 8B which shows a slack line 19A which is to be cut, and a perspective view of the hand 22C that produced a loop 19B in the slack string 19A as explained below. This situation presents a different mode of operation of the cutting tool than what is previously described herein. The user must use his/her hand 22C which is not the one of the forearm to which the cutting tool is attached. The hand 22C needs to gather up and hold a section of the line thus forming a loop 19B. The apex portion 19C of loop 19B is caused to be set onto the sliding guide 13 (not shown), preferable near the blade support opening 24 (not shown). Then the hand 22C pulls the loop 19B so that the apex portion 19C is forced into contact, indicated by bold arrows in FIG. 8B, with the sharp cutting edge 17. The general angle formed mutually by lateral interior surfaces 12A and 12B at apex 12C in sectional plane 8-8 should be small, probably less than 45 degrees so as the line is pulled against the cutting edge the line can bend around the cutting edge at a sharp angle, which is the condition for most effective cutting.

The details of the way the blade member 11 is embedded in and held firmly by the blade support can easily be determined by those familiar with the art. One embodiment is illustrated in FIG. 9 which is a perspective view from below of the cutting tool split along the center plane of symmetry. Note that the blade support, sliding guide, and cutting tool all share the same plane of symmetry. FIG. 9a shows a type of slot 40 that may be used to help support a blade member, perhaps in conjunction with an adhesive. FIG. 9b shows a blade member in place.

The foregoing detailed description and the accompanying drawings describe illustrative preferred embodiments of the invention. Other arrangements may be provided along the same likes. Accordingly, the invention is not limited to the precise embodiments shown in the drawings and described in detail hereinabove.

What is claimed is:

1. A cutting tool, comprising:
a sliding guide being adapted for placement on a user's forearm, said sliding guide having a length;
means for attaching said sliding guide to said user's forearm;
a blade support having means for holding a blade member, said blade member having a sharp cutting edge;
said blade support affixed to said sliding guide;
said blade support and said sliding guide together define a blade support opening having an entrance height, said blade support opening having access-limiting means adapted to provide protection from cutting human extremities.

2. A cutting tool as in claim 1 wherein said sharp cutting edge is “V”-shaped.

3. A cutting tool as in claim 2 wherein said sharp cutting edge is smooth.

4. A cutting tool as in claim 2 wherein said sharp cutting edge is serrated.

5. A cutting tool as in claim 1 wherein said sharp cutting edge is “U”-shaped.

6. A cutting tool as in claim 5 wherein said sharp cutting edge is smooth.

7. A cutting tool as in claim 5 wherein said sharp cutting edge is serrated.

8. A cutting tool as in claim 1 wherein said sharp cutting edge is linear.

9. A cutting tool as in claim 9 wherein said sharp cutting edge is smooth.

10. A cutting tool as in claim 9 wherein said sharp cutting edge is serrated.

11. A cutting tool as in claim 1 wherein said sliding guide and said blade support are integral and of molded plastic, metal, or any other rigid material.

12. A cutting tool as in claim 1 wherein length of said sliding guide is less than 5 centimeters.

13. A cutting tool as in claim 1 wherein length of said sliding guide is from 5 centimeters to less than 10 centimeters.

14. A cutting tool as in claim 1 wherein length of said sliding guide is from 10 centimeters to 15 centimeters.

15. A cutting tool as in claim 1 wherein length of said sliding guide is greater than 15 centimeters.

16. A cutting tool as in claim 1 wherein said entrance height is less than 2 millimeters.

17. A cutting tool as in claim 1 wherein said entrance height is from 2 millimeters to less than 4 millimeters.

18. A cutting tool as in claim 1 wherein said entrance height is from 4 millimeters to less than 6 millimeters.

19. A cutting tool as in claim 1 wherein said entrance height is from 6 millimeters to less than 9 millimeters.

20. A cutting tool as in claim 1 wherein said entrance height is from 9 millimeters to 12 millimeters.

21. A cutting tool as in claim 1 wherein said entrance height is greater than 12 millimeters.

22. A method of cutting line comprising the steps of:
wearing a cutting tool on a user's forearm, said cutting tool having a blade member confined within a blade support designed to prevent personal injury by interiorly locating said blade member within a blade support opening so that a line has access to said blade member but anything as large as a user's finger has no access to said blade, said blade support mounted on top and front end of a sliding guide having attachment means to said forearm, said sliding guide configured to guide said line into said blade member, said blade member configured for efficient cutting in a single pass;
pivoting said forearm across said line so that said sliding guide intercepts said line;
pulling back said forearm so that said line slides across said sliding guide engaging said blade member;
cutting line.

23. A method of cutting line comprising the steps of:
wearing a cutting tool on a user's forearm, said cutting tool having a blade member confined within a blade support designed to prevent personal injury by interiorly locating said blade member within a blade support opening so that a line has access to said blade member but anything as large as a user's finger has no access to said blade, said blade support mounted on top and front end of a sliding guide having attachment means to said forearm, said sliding guide configured to guide said line into said blade member, said blade member configured for efficient cutting in a single pass;
holding a section of said line with user's hand opposite hand of said forearm;
pulling said line into said blade member;
cutting line.

24. A cutting tool for hands-free cutting of line (spec needs to define line as including string, rope, fishing line, etc), which can be safely worn on a user's forearm, having a partially concealed blade to prevent personal injury, said partially concealed blade is configured for efficient line cutting in a single pass, comprising:
a sliding guide having a length, a long axis of symmetry, a front end, a top, and a bottom, said top of said sliding guide is convex and said bottom of said sliding guide is concave, said sliding guide being adapted for placement on a user's forearm;
means for attaching said sliding guide to said user's forearm;
a blade support having an outward-extending tongue elevated by a vertical section, said outward-extending tongue and said vertical section being a single member together forming said blade support approximating a sideways L-shape, said blade support having an interior surface and a center plane of symmetry, wherein a blade member is firmly affixed along the intersection of said interior surface and said center plane of symmetry of said blade support;
said blade support mounted on said top, said front end, and centered on said long axis of symmetry of said sliding guide, said blade support and said sliding guide together define a blade support opening having an entrance height;
said blade support opening having access-limiting means adapted to provide protection from cutting human extremities;
said blade member being planar having a sharp cutting edge arranged and mounted interiorly within said blade support so that said sharp cutting edge is pointed outward from said blade support opening.
